(19) United States
(12) Patent Application Publication
(10) Pub. No.: US 2025/0300455 A1
(43) Pub. Date: Sep. 25, 2025

(54) OVERVOLTAGE PROTECTION DEVICE

(71) Applicant: CITEL, PARIS (FR)

(72) Inventors: Mirko HARBOTT, PARIS (FR); Michael HOLZSCHUH, PARIS (FR)

(21) Appl. No.: 19/082,824

(22) Filed: Mar. 18, 2025

(30) Foreign Application Priority Data
Mar. 20, 2024 (FR) FR2402774

(51) Int. Cl. H02H 9/04

(52) U.S. Cl. CPC H02H 9/044; H02H 9/045

(57) ABSTRACT

An overvoltage protection device having a casing with an internal space, an earth branch, a positive branch, and a negative branch that join. The device also has an earth connector, n1 positive connectors, n1 being greater or equal to 3, and n2 negative connectors, n2 being greater than or equal to 3.

### TECHNICAL FIELD

The invention relates to the field of overvoltage protection devices.

It notably concerns a protection device for a photovoltaic installation and a photovoltaic installation including such a protection device.

However, the protection device can equally well be used for other applications and notably in low-current DC networks.

### TECHNOLOGICAL BACKGROUND

Photovoltaic installations are generally equipped with an inverter for converting the direct current produced by the photovoltaic panels into alternating current which can be injected into the electrical grid or used for alternating current devices.

In order to protect the “direct current” part of the photovoltaic installation, notably the inverter, the photovoltaic panels, the cables and other electrical equipment, it is known to equip photovoltaic installations with an electrical box comprising one or more overvoltage protection devices. Each protection device is connected to earth and is disposed between the inverter and at least one string of photovoltaic panels in series.

In order to limit the number of protection devices when the photovoltaic installation includes a plurality of strings of photovoltaic panels it is known to equip the electrical box with two electrical terminal blocks, respectively positive and negative, disposed upstream of each overvoltage protection device. The positive electrical terminal block is connected, on the one hand, to a plurality of wires each of which is electrically connected to the positive terminal of one of the strings of photovoltaic panels in series, and, on the other hand, by another wire to the positive connector of the overvoltage protection device. In exactly the same way, the negative electrical terminal block is connected, on the one hand, to a plurality of wires each of which is electrically connected to the negative terminal of one of the strings of photovoltaic panels in series, and, on the other hand, by another wire to the negative connector of the overvoltage protection device. Thus a plurality of strings of photovoltaic panels are connected to each protection device by the positive and negative electrical terminal blocks.

However, such an arrangement is not entirely satisfactory, notably in that it necessitates the use of additional cables and electrical terminal blocks that crowd the electrical boxes and necessitate additional wiring operations.

### SUMMARY OF THE INVENTION

One idea behind the invention is therefore to provide an overvoltage protection device enabling the aforementioned problems to be solved and notably making it possible to reduce the overall size of the protection boxes and to simplify the installation operations.

In accordance with one embodiment, the invention provides an overvoltage protection device comprising:
a casing including an internal space,
an earth branch, a positive branch and a negative branch that join and are housed in the internal space of the casing, the positive branch and the negative branch each including at least one protection element that is configured to conduct electricity when said protection element is subjected to a voltage exceeding a voltage threshold,
an earth connector that is housed in the internal space of the casing, electrically connected to the earth branch and intended to be connected to earth,
n1 positive connectors that are housed in the internal space of the casing and connected to the positive branch, n1 being greater than or equal to 3, and
n2 negative connectors that are housed in the internal space of the casing and connected to the negative branch, n2 being greater than or equal to 3.

Thanks to these features, such a protection device is therefore simpler to install. Thus, for a photovoltaic installation for example, the same protection device can be connected to a plurality of strings of photovoltaic panels and to an inverter in order to protect them in a simple manner and with a reduced overall size, without for example using additional electrical terminal blocks, as in the prior art.

In some embodiments, such an overvoltage protection device has one or more of the following features.

In accordance with one embodiment, n1 is greater than or equal to 4 and n2 is greater than or equal to 4. Thus at least three different strings of photovoltaic panels can be connected to the same protection device.

In accordance with one embodiment, the positive branch and the negative branch respectively include a positive connecting bar to which the positive connectors are connected and a negative connecting bar to which the negative connectors are connected. This simplifies the connection of the positive and negative connectors to the positive and negative branches.

In accordance with one embodiment, the casing includes a base and a cap that are fixed to one another and together define the internal space.

In accordance with one embodiment, the earth branch, the positive branch and the negative branch are joined at a central connection point.

In accordance with one embodiment, the central connection point is equipped with a heat-sensitive disconnector device; the heat-sensitive disconnector device includes at least one thermal cut-out that makes the electrical connection between the positive, negative and earth branches. The thermal cut-out is in thermal contact with an electrode of the protection elements of the positive and negative branches and is adapted to melt at a temperature above a temperature threshold.

In accordance with one embodiment, the protection device also includes an arc extinguisher device, the arc extinguisher device comprising an insulative flap that is mobile and urged by an elastic member toward a cut-out position in which it takes the place of the thermal cut-out so that when the thermal cut-out melts the insulating flap is positioned, in the cut-out position, in the place of the thermal cut-out. Such an arc extinguisher device therefore prevents the occurrence of an electrical arc.

In accordance with one embodiment, the base is configured to be fixed to a fixing rail.

In accordance with one embodiment, the cap has a front face including a plurality of orifices each of which faces one of the positive connectors, the negative connectors or the earth connector. The wires are therefore connected via the front face of the protection device, which simplifies the installation operations.

In accordance with one embodiment, the orifices are coaxial with an axis at an angle α between 30 and 60° to the horizontal. This facilitates connecting the wires and conforming to the maximum radii of curvature of said wires.

In accordance with one embodiment, the front face of the cap carries visual indications associated with each of the orifices, said visual indications representing the assignment of the wire intended to pass through said orifice; the visual indications associated with the orifices facing the positive connector nearest the protection component of the positive branch and facing the negative connector nearest the protection component of the negative branch respectively represent an assignment to the positive terminal of the inverter and to the negative terminal of the inverter. This enables maximum protection of the inverter.

In accordance with one embodiment, the cap includes a protruding portion that projects toward the front from the front face of the cap and in which the protection elements are at least partially housed.

In accordance with one embodiment, the positive connecting bar, the positive connectors and the orifices facing the positive connectors are disposed laterally on a first side of the protruding portions and the negative connecting bar, the negative connectors and the orifices facing the negative connectors are disposed laterally on a second side of the protruding portion opposite the first side. This notably makes it possible to limit the risks of errors during installation operations.

In accordance with one embodiment, the orifices facing the positive connectors and the orifices facing the negative connectors respectively form first and second rows of orifices that are each aligned vertically. This notably makes it possible to limit the overall size of the protection device.

In accordance with one embodiment, the earth connector, the positive connectors and the negative connectors are connectors without screws chosen from spring-loaded connectors and lever connectors. This further facilitates the installation operations.

In accordance with one embodiment, the earth branch includes at least one protection element that is configured to conduct electricity when said protection element is subjected to a voltage above a voltage threshold.

In accordance with one embodiment, the protection elements are each chosen from gas spark gaps, air spark gaps, varistors, overvoltage suppressor diodes and overvoltage suppressor thyristors.

In accordance with one embodiment, the invention also provides a photovoltaic installation comprising an inverter having a positive terminal and a negative terminal, a plurality of strings of photovoltaic panels each having a positive terminal and a negative terminal, and an overvoltage protection device of the aforementioned type, n1 being greater than or equal to 3 and n2 being greater than or equal to 3 and in which one of the positive connectors is connected to the positive terminal of the inverter and at least two other positive connectors are each connected to the positive terminal of one of the strings of photovoltaic panels and in which one of the negative connectors is connected to the negative terminal of the inverter and at least two other negative connectors are each connected to the negative terminal of one of the strings of photovoltaic panels.

### BRIEF DESCRIPTION OF THE FIGURES

The invention will be better understood and other aims, details, features and advantages thereof will become more clearly apparent in the course of the following description of a plurality of particular embodiments of the invention provided by way of non-limiting illustration and with reference to the appended drawings.

FIG. 1 is a diagrammatic representation of a photovoltaic installation equipped with an overvoltage protection device.

FIG. 2 is a diagrammatic representation of a second variant of a protection device.

FIG. 3 is a diagrammatic representation of a third variant of a protection device.

FIG. 4 is a diagrammatic representation of a fourth variant of a protection device.

FIG. 5 is a diagrammatic representation of a fifth variant of a protection device.

FIG. 6 is a diagrammatic representation of a sixth variant of a protection device.

FIG. 7 is a perspective view of one embodiment of an overvoltage protection device.

FIG. 8 is a side view of the overvoltage protection device from FIG. 7, the lateral face of the casing of the protection device being omitted so as to enable viewing of the negative connection bar and the associated negative connectors.

FIG. 9 is a side view similar to that in FIG. 8 but representing the other side of the protection device so as to enable viewing of the positive connection bar and the associated positive connectors.

FIG. 10 is a diagrammatic side view of the overvoltage device from FIGS. 7, 8 and 9 depicting the negative connection bar.

### DESCRIPTION OF EMBODIMENTS

A protection device intended for a photovoltaic installation is described below. However, this application is mentioned only by way of example and such a protection device can equally well be used for other applications.

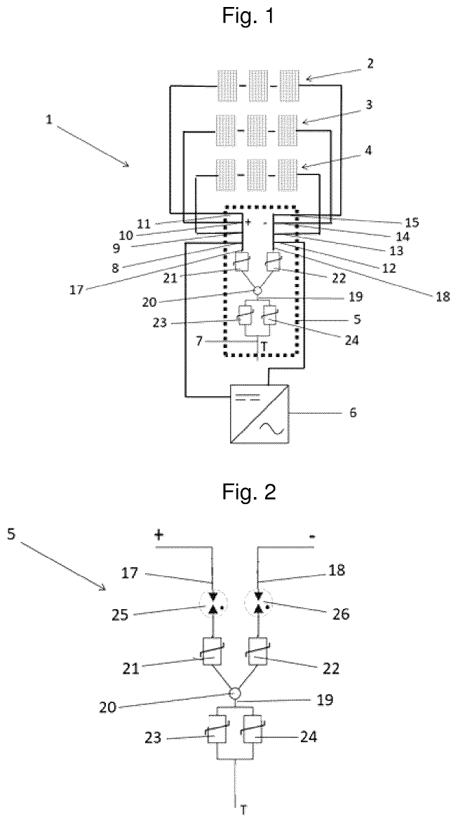

A photovoltaic installation 1 is described with reference to FIG. 1. The photovoltaic installation 1 includes a plurality of strings of photovoltaic panels 2, 3, 4, for example three of them in the embodiment represented, each comprising a plurality of photovoltaic panels disposed in series, an overvoltage protection device 5 and an inverter 6 that is notably configured to convert the direct current produced by the photovoltaic panels into alternating current.

The overvoltage protection device 5 includes an earth connector 7 that is connected to earth.

The protection device 5 also includes a plurality of positive connectors 8, 9, 10, 11, namely:
a positive connector 8 that is electrically connected to the positive terminal of the inverter 6, and
at least two positive connectors 9, 10, 11 that are electrically connected to the positive terminal of a respective string of photovoltaic panels 2, 3, 4. Thus if the number of positive connectors is at least three, there can be more of them and for example four of them as in the embodiment represented.

Similarly, the protection device 5 includes a plurality of negative connectors 12, 13, 14, 15, namely:
a negative connector 12 that is electrically connected to the negative terminal of the inverter 6, and
at least two negative connectors 13, 14, 15 that are electrically connected to the negative terminal of a respective string of photovoltaic panels 2, 3, 4. The number of negative connectors 13, 14, 15 is also at least three, but can be greater and for example four as in the embodiment represented.

The protection device 5 can therefore be used to protect a plurality of strings of photovoltaic panels 2, 3, 4 in a simple manner and without using intermediate electrical terminal blocks, as in the prior art. Obviously, if the photovoltaic installation includes more than three strings of photovoltaic panels 2, 3, 4 and the protection device includes only four positive connectors 8, 9, 10, 11 and four negative connectors 12, 13, 14, 15, it then includes a number of protection devices 5 determined accordingly.

The circuit of the protection device 5 includes three branches 16, 17, 18, namely a positive branch 17, a negative branch 18 and an earth branch 19 that are respectively electrically connected to the positive connectors 8, 9, 10, 11, to the negative connectors 12, 13, 14, 15 and to the earth connector 7. The three branches 16, 17, 18 are joined, for example, at a central connection point 20. Such an electrical circuit therefore has a so-called Y configuration.

At least two of the three branches 16, 17, 18, namely the positive branch 17 and the negative branch 18, include one or more protection elements 21, 22 chosen for example from gas spark gaps, air spark gaps, varistors, overvoltage suppressor diodes and overvoltage suppressor thyristors. When such a protection element 21, 22 is subjected to a voltage below an activation voltage, it acts like a high-impedance element so that no current passes through it. To the contrary, if it is subjected to a voltage above the activation voltage the protection element 21, 22 acts like an element of virtually zero impedance so as to shunt the overvoltage to earth. The earth branch 19 may also be equipped with one or more protection elements 23, 24.

In the FIG. 1 embodiment, the positive branch 17 and the negative branch 18 are each equipped with a protection element, namely a varistor 21, 22. The earth branch 19 includes two varistors 23, 24 electrically connected in parallel with one another.

In accordance with one advantageous embodiment, the central connection point 20 is equipped with a heat-sensitive disconnector device, not depicted, which includes at least one thermal cut-out that makes the electrical connection between the aforementioned positive branch 17, negative branch 18 and earth branch 19. The thermal cut-out is in thermal contact with an electrode of the protection elements 21, 22 of the positive branch 17 and the negative branch 18 and is adapted to melt at a temperature above a threshold temperature. Thus, in the case of an overvoltage between the positive branch 17 and the negative branch 18 or between either the positive branch 17 or the negative branch 18 and the earth branch 19, at least one of the varistors 21, 22 heats up, which leads to an increase in the temperature of the thermal cut-out. The thermal cut-out melts when it reaches a temperature above its melting point. The heat-sensitive disconnector device is then in a disconnected state in which it no longer makes the electrical connection between the three branches 17, 18, 19, which enables the protection device 5 to be taken out of service at its end of life. By way of example, such heat-sensitive disconnector devices are described in more detail in the application EP3319194.

In accordance with one advantageous embodiment, the protection device 5 also includes an arc extinguisher device, also not represented, comprising an insulative flap that is mobile and urged by an elastic member toward a cut-out position in which it is positioned in place of the thermal cut-out so that when the thermal cut-out melts the insulating flap in the cut-out position takes the place of the thermal cut-out, therefore preventing the occurrence of an electrical arc. Such arc extinguisher devices are also described in the aforementioned application EP3319194.

The protection device 5 can also include a remote signalling module including a connector adapted and intended to be connected to a distant monitoring station and a switch that is electrically connected to said connector. The switch includes a blade that is disposed facing the insulating flap in such a manner that said blade is moved from an open state to a closed state when the insulating flap is moved from the original position to the cut-out position.

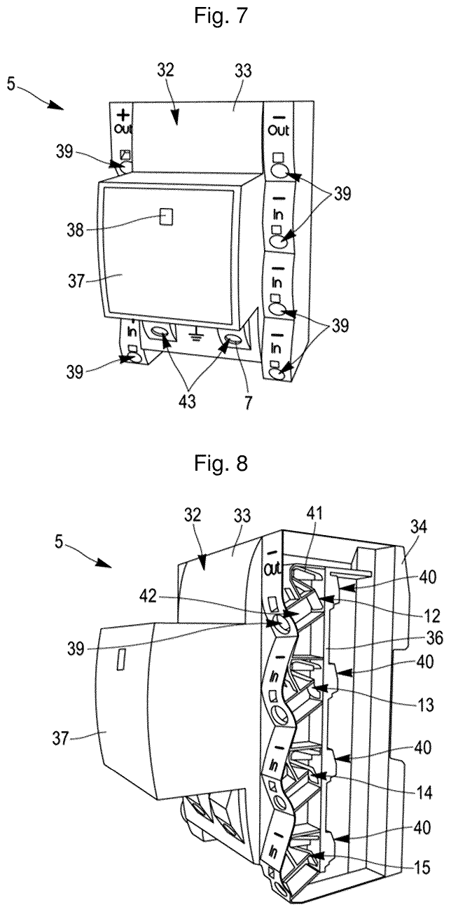

In accordance with one advantageous embodiment, the protection device 5 also includes a visual indicator device that includes an indicator shutter 38, as seen in FIG. 7, said indicator shutter 38 being mobile between a first position representing an in-service state of the protection device 5 and a second position representing an out-of-service state of the protection device 5. The indicator shutter 38 is kinematically connected to the insulating flap of the arc extinguisher device in such a manner that the indicator shutter 38 is moved to its second position, representing an out-of-service state of the protection device 5, when the insulating flap is moved toward its cut-out position.

The electrical circuit and protection elements are described hereinafter by way of example only and it is obvious that they can vary according to the envisaged application. Thus FIGS. 2 to 6 represent the circuit of the protection device 5 in accordance with other variant embodiments.

The FIG. 2 variant embodiment differs from that described hereinabove with reference to FIG. 1 in that the positive branch 17 and the negative branch 18 are each equipped with two protection elements in series, namely a varistor 21, 22 and a gas spark gap 25, 26. Such an embodiment is advantageous in that it makes it possible to prevent leakage currents between the positive branch 17 and the negative branch 18 and the earth branch 19 or between the positive branch 17 and the negative branch 18.

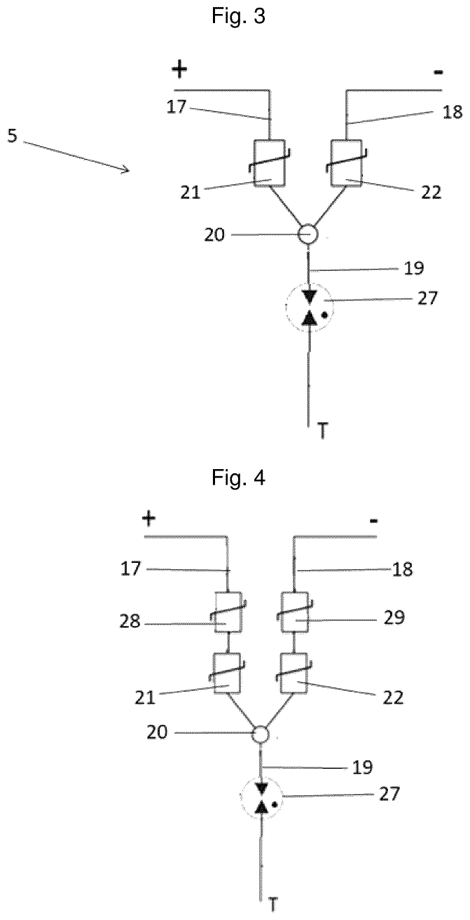

The FIG. 3 variant embodiment differs from that described hereinabove with reference to FIG. 1 in that the earth branch 19 includes a gas spark gap 27 in place of the two varistors 23, 24 connected in parallel with one another. This makes it possible to reduce the overall size of the protection device 5 and to prevent leakage currents between the positive branch 17 or the negative branch 18 and the earth branch 19.

The FIG. 4 variant embodiment differs from that described hereinabove with reference to FIG. 1 in that, on the one hand, the positive branch 17 and the negative branch 18 are each equipped with two varistors 21, 28 and 22, 29 in series, and in that, on the other hand, the earth branch 19 includes a gas spark gap 27 in place of the two varistors 23, 24. The two varistors 21, 28 and 22, 29 in series in each of the positive branch 17 and the negative branch 18 make it possible to increase the maximum discharge current that can be evacuated while the gas spark gap 27 in place of the two varistors 23, 24 makes it possible to reduce the overall size and to prevent leakage currents between the positive branch 17 or the negative branch 18 and the earth branch 19.

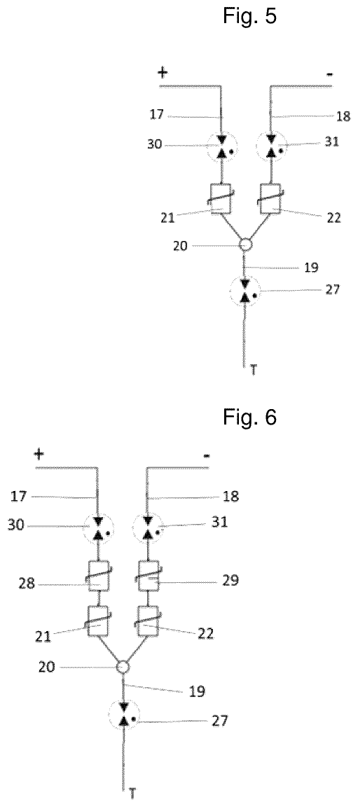

The FIG. 5 variant embodiment differs from that described hereinabove with reference to FIG. 1 in that, on the one hand, the positive branch 17 and the negative branch 18 are each equipped with a varistor 21, 22 and a gas spark gap 30, 31 in series, and, on the other hand, the earth branch 19 includes a gas spark gap 27 in place of the two varistors 23, 24 electrically connected in parallel with one another. The varistor 21, 22 and the gas spark gap 30, 31 in series in each of the positive branch 17 and the negative branch 18 make it possible to prevent leakage currents between the positive branch 17 or the negative branch 18 and the earth branch 19 and between the positive branch 17 and the negative branch 18 while the gas spark gap 27 replacing the two varistors 23, 24 makes it possible to reduce the overall size.

The FIG. 6 variant embodiment differs from that described hereinabove with reference to FIG. 1 in that, on the one hand, the positive branch 17 and the negative branch 18 are each equipped with two varistors 21, 28 and 22, 29 and a gas spark gap 30, 31 in series, and, on the other hand, the earth branch 19 includes a gas spark gap 27. The two varistors 21, 28 and 22, 29 in series make it possible to increase the maximum discharge current that can be evacuated, the gas spark gaps 30, 31 in the positive branch 17 and the negative branch 18 make it possible to reduce the leakage currents, while the gas spark gap 27 makes it possible to reduce the overall size.

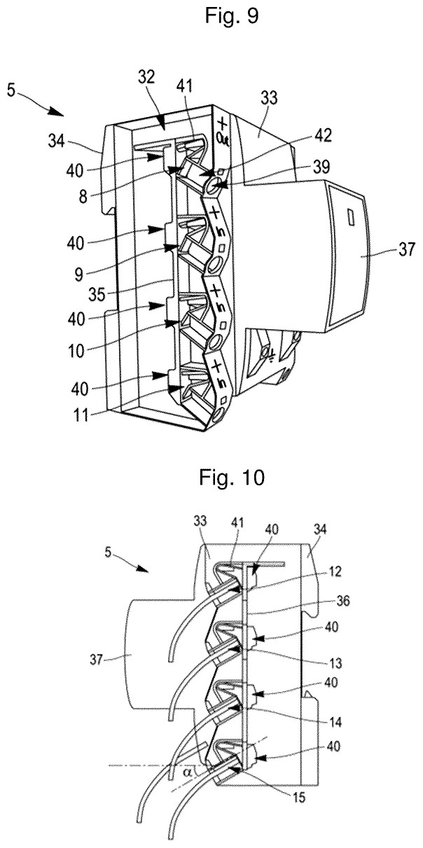

There is described below with reference to FIGS. 7, 8 and 9 the structure of a protection device 5 and notably of its casing 32 and its connectors 7, 8, 9, 10, 11, 12, 13, 14, 15. The aforementioned positive branch 17, negative branch 18 and earth branch 19 and the protection elements 21, 22, 23, 24 are housed in the casing 32. The casing 32 is for example made of plastic material. The casing 32 includes a base 34 and a cap 33 that are configured to be fixed to one another and define between them an internal space in which the aforementioned components are housed. As represented in FIGS. 8 and 9, the base 34 is configured to be fixed to a fixing rail, not represented, such as a DIN rail (that is to say a rail standardised by the German standardisation institute, “Deutsches Institut für Normung”), for example. To this end, the base 34 has a rear face that is equipped with means for fixing it to the rail.

Furthermore, the positive branch 17 and the negative branch 18 include a respective positive connection bar 35, seen in FIG. 9, to which the positive connectors 8, 9, 10, 11 are directly connected and a negative connection bar 36, seen in FIGS. 8 and 10, to which the negative connectors 12, 13, 14, 15 are directly connected. The connecting bars 35, 36 are for example made of copper.

In the embodiment represented the two connecting bars 35, 36 are disposed along respective lateral edges of the casing 32. Said connecting bars 35, 36 are therefore positioned laterally on respective opposite sides of a protruding portion 37 of the casing 32 that projects toward the front from the front face of the cap 33 and in which the protection elements are at least partially housed. The two connecting bars 35, 36 extend vertically.

Each of the connecting bars 35, 36 is equipped with at least three connectors 8, 9, 10, 11 and 12, 13, 14, 15 and for example four connectors in the embodiment represented. Thus if the protection device is intended for a photovoltaic installation 1, one of the connectors is intended to be connected to a wire leading to one of the terminals of the inverter 6 and the others are each intended to be connected to a wire leading to one of the strings of photovoltaic panels 2, 3, 4.

Each of the connectors 7; 8, 9, 10, 11 and 12, 13, 14, 15 is arranged facing a respective orifice 39 in the front face of the cap 33 of the casing 32 that is intended to have a wire passed through it for said wire to be connected to the corresponding connectors 7; 8, 9, 10, 11 and 12, 13, 14, 15.

The front face of the cap 33 includes two rows of orifices 39 that are aligned on vertical axes and are disposed along respective lateral edges of said front face. The two rows of orifices 39 are respectively disposed facing the positive connectors 8, 9, 10, 11 and the negative connectors 12, 13, 14, 15.

Furthermore, although the connectors 7; 8, 9, 10, 11 and 12, 13, 14, 15 can be of any type and notably screw connectors, they are advantageously connectors with no screws, that is to say that do not include screws intended to fasten the end of the electrical wire to said connector.

Numerous variants of connectors with no screws can be envisaged. By way of example, the connectors with no screws can notably be chosen from:
spring-loaded connectors that use a spring mechanism to hold the wire in place; it suffices to push the wire into the orifice provided for this purpose for the spring to make a secure connection, and
lever connectors that use a lever to clamp the wire in place; raising the lever enables the wire to be inserted, after which lowering the lever clamps it in place.

In the embodiment represented, the connectors 7; 8, 9, 10, 11 and 12, 13, 14, 15 are spring connectors. The connecting bars 35, 36 include, for each connector, an opening 40 intended to receive a bared end of a wire. The connectors 7; 8, 9, 10, 11 and 12, 13, 14, 15 each include a metal, advantageously copper, leaf spring 41 that has one end blocking said opening 40. The leaf spring 41 is configured to be deformed in order to enable the bared end of the wire to be inserted in the opening 40 and to clamp said bared end of the wire against one of the edges of the opening 40.

Furthermore, the connectors 7; 8, 9, 10, 11 and 12, 13, 14, 15 each include a wire guide 42 that is disposed in line with one of the orifices 39. The guide wire 42 aims to facilitate the insertion of the wire in the connector 7; 8, 9, 10, 11 and 12, 13, 14, 15 and to ensure correct positioning of the wire to make its electrical connection with the connector 7; 8, 9, 10, 11 and 12, 13, 14, 15.

As represented in FIG. 10, the orifices 39 and the wire guides 42 are advantageously coaxial about an axis that is oriented at an angle α between 30 and 60°, for example of the order of 45°, to the horizontal, which facilitates connecting the wires and complying with the maximum radii of curvature of said wires.

In a similar manner, the front face of the cap 33 also includes one or more so-called earth orifices 43, visible in FIG. 7, intended for the passage of an earth wire, and a connector 7, not visible in FIG. 7, that is connected to the earth branch of the protection device 5. The earth orifice or orifices 43 is or are disposed between the aforementioned two rows of orifices 39 and advantageously below the protruding portion 37.

Furthermore, in accordance with one advantageous embodiment, the front face of the casing 32 includes visual indications associated with each of the connectors 7; 8, 9, 10, 11 and 12, 13, 14, 15 and aiming to indicate to the operator the assignment of the wire to be associated with each of the connectors 7; 8, 9, 10, 11 and 12, 13, 14, 15. Accordingly, by way of example, in FIGS. 7 and 8 the front face of the casing 32 includes the following indications:
“+ Out” for the connector 8 that is intended to be electrically connected to the positive terminal of the inverter 6,
“− Out” for the connector 12 that is intended to be electrically connected to the negative terminal of the inverter 6,
“+ In” for the connectors 9, 10, 11 that are intended to be electrically connected to the positive terminal of one of the strings of photovoltaic panels 2, 3, 4,
“− In” for the connectors 13, 14, 15 that are intended to be electrically connected to the negative terminal of one of the strings of photovoltaic panels 2, 3, 4.

The connectors 8, 12 that are intended to be connected to the inverter 6 are advantageously connected to portions of the connecting bars 35, 36 that are electrically closer to the protection elements than the portions of the connecting bars 35, 36 that are connected to the other connectors. This enables maximum protection of the inverter 6, which is the most critical device.

However, in other embodiments the front face of the casing 32 has no visual indications or has a different arrangement of the indications. Thus it is possible to provide a plurality of indications (“+ In” or “− In” for example) representing equipment disposed upstream of the protection device.

Although the invention has been described with reference to a plurality of particular embodiments, it is obvious that it is in no way limited to them and that it encompasses all technical equivalents of the means described and combinations thereof if the latter fall within the scope of the invention.

Use of the verb “to include” or “to comprise” and its conjugate forms does not exclude the presence of elements or steps other than those stated in a claim. In the claims, any reference sign between parentheses should not be interpreted as a limitation of the claim.

1. An overvoltage protection device comprising:
a casing including an internal space,
an earth branch, a positive branch and a negative branch that join and are housed in the internal space of the casing, the positive branch and the negative branch each including at least one protection element that is configured to conduct electricity when said protection element is subjected to a voltage exceeding a voltage threshold,
an earth connector that is housed in the internal space of the casing, electrically connected to the earth branch and intended to be connected to earth,
n1 positive connectors that are housed in the internal space of the casing and connected to the positive branch, n1 being greater than or equal to 3, and
n2 negative connectors that are housed in the internal space of the casing and connected to the negative branch, n2 being greater than or equal to 3, wherein the casing includes a base and a cap that are fixed to one another and together define the internal space, the base being configured to be fixed to a fixing rail.

2. The overvoltage protection device according to claim 1, wherein n1 is greater than or equal to 4 and n2 is greater than or equal to 4.

3. The overvoltage protection device according to claim 1, wherein the positive branch and the negative branch respectively include a positive connecting bar to which the positive connectors are connected and a negative connecting bar to which the negative connectors are connected.

4. The overvoltage protection device according to claim 1, wherein the cap has a front face including a plurality of orifices each of which faces one of the positive connectors, the negative connectors or the earth connector.

5. The overvoltage protection device according to claim 4, wherein the orifices are coaxial with an axis at an angle α between 30 and 60° to the horizontal.

6. The overvoltage protection device according to claim 4, wherein the front face of the cap carries visual indications associated with each of the orifices, said visual indications representing the assignment of the wire intended to pass through said orifice, and wherein the visual indications associated with the orifices facing the positive connector nearest the protection component of the positive branch and facing the negative connector nearest the protection component of the negative branch respectively represent an assignment to the positive terminal of an inverter of a photovoltaic installation and to the negative terminal of said inverter.

7. The overvoltage protection device according to claim 1, wherein the cap includes a protruding portion that projects toward the front from the front face of the cap and wherein the protection elements are at least partially housed.

8. The overvoltage protection device according to claim 7, wherein the positive branch and the negative branch respectively include a positive connecting bar to which the positive connectors are connected and a negative connecting bar to which the negative connectors are connected, wherein the positive connecting bar, the positive connectors and the orifices facing the positive connectors are disposed laterally on a first side of the protruding portion and the negative connecting bar, the negative connectors and the orifices facing the negative connectors are disposed laterally on a second side of the protruding portion opposite the first side.

9. The overvoltage protection device according to claim 1, wherein the orifices facing the positive connectors and the orifices facing the negative connectors respectively form first and second rows of orifices that are each aligned vertically.

10. The overvoltage protection device according to claim 1, wherein the earth connector, the positive connectors and the negative connectors are connectors without screws chosen from spring-loaded connectors and lever connectors.

11. The overvoltage protection device according to claim 1, wherein the earth branch includes at least one protection element that is configured to conduct electricity when said protection element is subjected to a voltage above a voltage threshold.

12. The overvoltage protection device according to claim 1, wherein the protection elements are each chosen from gas spark gaps, air spark gaps, varistors, overvoltage suppressor diodes and overvoltage suppressor thyristors.

13. A photovoltaic installation comprising an inverter having a positive terminal and a negative terminal, a plurality of strings of photovoltaic panels each having a positive terminal and a negative terminal, and an overvoltage protection device according to claim 1, wherein one of the positive connectors is connected to the positive terminal of the inverter and at least two other positive connectors are each connected to the positive terminal of one of the strings of photovoltaic panels and wherein one of the negative connectors is connected to the negative terminal of the inverter and at least two other negative connectors are each connected to the negative terminal of one of the strings of photovoltaic panels.
